(19) United States
(12) Patent Application Publication
(10) Pub. No.: US 2005/0236280 A1
(43) Pub. Date: Oct. 27, 2005

(54) Methods for analyzing inorganic components of an electrolytic solution, and /or cleaning an electrochemical analytical cell

(76) Inventors: Jianwen Han, Danbury, CT (US); Mackenzie E. King, Southbury, CT (US); Weihua Wang, Danbury, CT (US)

Correspondence Address: ATMI, INC., 7 COMMERCE DRIVE, DANBURY, CT, 06810, US

(21) Appl. No.: 10/833,193

(22) Filed: Apr. 27, 2004

(51) Int. Cl. G01N 27/26

(52) U.S. Cl. 205/786.5; 205/789; 205/789.5

(57) ABSTRACT

Cyclic electric potential is employed for measuring copper and sulfuric acid concentration in an electrochemical copper-plating solution. Such cyclic electric potential is further employed for cleaning electrode surface in an electrochemical analytical cell.

### BACKGROUND OF THE INVENTION

1. Field of the Invention

The present invention relates to methods for determining the presence and/or concentration of an inorganic component in an electrolytic solution, as well as to methods for cleaning an electrochemical analytical cell.

2. Description of the Related Art

In electrochemical deposition (ECD) process, the rigorous control of the relative proportions of respective inorganic and organic ingredients in the ECD bath is critical to the achievement of satisfactory results in the rate of metal film formation and the quality of the film so formed. During the use of the plating bath solution, the plating process may be affected by depletion of inorganic components and organic additives as well as by organic byproduct formation. The ECD bath chemistry therefore must be maintained by periodic replacement of a part or the entire ECD bath. It is therefore important to continuously or periodically monitor the concentrations of inorganic and/or organic components in the ECD bath, and responsively add respective components to the bath to maintain the composition of the bath in an effective state for the electrochemical deposition operation.

In conventional ECD bath analysis, concentrations of the inorganic components have been determined by titration techniques, which are complicated, time-consuming, labor-intensive and inaccurate.

It is thus an object of the present invention to provide a new method for determining the concentration of an inorganic component of interest in an ECD bath.

It is another object of the present invention to provide a method for determining presence and/or concentration of an inorganic component of interest in an electrolytic solution in general.

Electrochemical analytical cells comprising one or more measuring electrodes are currently used for analyzing the ECD bath. However, the presence of surface-active materials in the sample ECD solution leads to formation of a surface residual layer on the electrode surface, resulting in electrode passivation or a change in the electrode surface state, and causing significant measurement errors after such measuring electrode is used for an extended period of time. Maintenance of a clean, reproducible electrode surface therefore is of critical importance in making meaningful electroanalytical measurements.

Conventionally, various electrode-cleaning techniques were employed for removing the surface residual layer and reactivating the electrode, among which ex situ mechanical polishing of the electrode surface has been proven to be the simplest method. However, deleterious scratching and cleaving of the electrode surface during polishing have significant influence on the electroanalytical measurement results and lead to measurement errors. Moreover, mechanical polishing of the electrode requires removal of such electrode from the analytical cell, resulting in prolonged system down time and reduced measurement efficiency. Use of power ultrasound, in particular ultrasound transmitted directionally via a horn-type transducer probe, has also been utilized for depassivating the electrode surface via cavitation. However, damages to the electrode surface caused by the cavitation are evident, especially when high ultrasound intensities are employed.

It is therefore a further object of the present invention to provide a method for in situ cleaning and depassivating an electrode, with significantly shortened system down time and reduced damages to the electrode surface.

A still further object of the present invention relates to a method for concurrently cleaning a measuring electrode of an electrochemical analytical cell and determining the presence and/or concentration of an inorganic contaminating species in such electrochemical analytical cell.

Other objects and advantages will be more fully apparent from the ensuring disclosure and appended claims.

### SUMMARY OF THE INVENTION

The present invention in one aspect relates to a method for cleaning an electrolytic analytical cell, comprising the steps of:
(a) flushing such electrolytic analytical cell with an electrolytic cleaning solution;
(b) electrically stripping a measuring electrode of such analytical cell for removal of a metal layer from the measuring electrode, wherein such metal layer is formed on the measuring electrode during a previous analysis;
(c) subsequently, filling the electrolytic analytical cell with a metal-free electrolytic solution, wherein the measuring electrode and an auxiliary electrode are immersed in such electrolytic solution;
(d) applying a cyclic electric potential between the measuring and auxiliary electrodes and monitoring current response of such electrolytic solution;
(e) determining presence and/or concentration of metal residue in such electrolytic solution, based on characteristic current response of the electrolytic solution under the cyclic electric potential; and
(f) optionally, repeat steps (a)-(e).

Another aspect of the present invention relates to a method for determining presence and/or concentration of an inorganic component in an electrolytic solution, comprising the steps of:
(a) immersing in such electrolytic solution a first electrode and a second electrode;
(b) applying a cyclic electric potential between the first and second electrodes;
(c) concurrently, monitoring the electrical current that flows through the electrolytic solution between the first and second electrodes; and
(d) determining the presence and/or concentration of the inorganic component in such electrolytic solution, based on characteristic current response of the electrolytic solution under the cyclic electric potential.

The cyclic electric potential applied between the first and second electrodes preferably cycles between about −2 volts to about +4 volts, and more preferably between about −1 volts to about +2 volts. More preferably, such cyclic electric potential is characterized by a scan rate of from about 100 mV/second to about 500 mV/second.

In a preferred embodiment of the present invention, the electrolytic solution comprises an electrochemical deposition (ECD) solution, while the inorganic component of interest is a metal component to be deposited. Alternatively, the inorganic component of interest may be a non-metal component, such as an acid or a base. Further, the electrolytic solution to be analyzed may be any other type of electrolytic solution, including but not limited to an electrolytic cleaning solution.

Preferably, the presence and/or concentration of the inorganic component in the sample electrolytic solution is determined by comparing the characteristic current response of such sample electrolytic solution with current responses of one or more calibration solutions containing the inorganic component at unique, known concentrations.

More preferably, current response curves, which plot electric current as a function of the cyclic electric potential, are constructed for both the sample electrolytic solution and the calibration solutions, and the presence and/or concentration of the inorganic component in the sample electrolytic solution is determined by comparing the integrated area of a current peak in the current response curve of the sample solution with the integrate areas of corresponding current peaks in the current response curves of the calibration solutions.

Another aspect of the present invention relates to a method for determining presence and/or concentration of copper in an electrolytic solution that contains copper or is susceptible to presence of copper. Such method comprises the steps of:
(a) immersing in such electrolytic solution a first electrode and a second electrode;
(b) applying a cyclic electric potential between the first and second electrodes;
(c) concurrently, monitoring the electrical current that flows through the electrolytic solution between the first and second electrodes; and
(d) determining the presence and/or concentration of copper in such electrolytic solution, based on characteristic current response of the electrolytic solution under the cyclic electric potential.

Preferably, the electrolytic solution of interest is an electrochemical copper plating solution. Alternatively, the electrolytic solution may be any other type of electrolytic solution that contains copper ions or is susceptible to the presence of copper ions.

Still another aspect of the present invention relates to a method for determining sulfuric acid concentration in an electrolytic solution containing the same. Such method comprises the steps of:
(a) immersing in such electrolytic solution a first electrode and a second electrode;
(b) applying a cyclic electric potential between the first and second electrodes;
(c) concurrently, monitoring the electrical current that flows through the electrolytic solution between the first and second electrodes; and
(d) determining the presence and/or concentration of sulfuric in such electrolytic solution, based on characteristic current response of the electrolytic solution under the cyclic electric potential.

Preferably, the electrolytic solution of interest is an electrochemical copper plating solution that comprises copper sulfate, sulfuric acid, and chloride. Alternatively, the electrolytic solution may be any other type of electrolytic solution that contains sulfuric acid.

A further aspect of the present invention relates to a method for cleaning a measuring electrode, comprising the steps of:
(a) immersing such measuring electrode and an auxiliary electrode in a sample electrolytic solution or an electrolytic cleaning solution; and
(b) applying a cyclic electric potential between the measuring electrode and the auxiliary electrode for in situ cleaning and depassivating the measuring electrode.

The term “auxiliary electrode” as used herein refers to any electrode besides the measuring electrode. Such auxiliary electrode may include, but is not limited to, a reference electrode in an electrochemical analytical cell, and additional electrodes provided in such electrochemical analytical cell.

The electric potential applied on such measuring electrode and auxiliary electrode preferably cycles between about −2 volts to about +4 volts, more preferably between about −1 volts to about +2 volts, and most preferably between about −0.8 volts to about +1.3 volts, for in situ cleaning and depassivating the measuring electrode.

Preferably, both the measuring and auxiliary electrodes are immersed in an electrolytic cleaning solution. More preferably, such electrolytic cleaning solution comprises sulfuric acid at a concentration of from about 0.1M to about 0.3M. Most preferably, such electrolytic cleaning solution further comprises potassium sulfate at a concentration of from about 0.2M to about 0.6M.

A still further aspect of the present invention relates to a “flow-stripping” method for cleaning a measuring electrode with a thin metal layer coated thereon. Such method comprises the steps of:
(a) electrochemically stripping the thin metal layer off the measuring electrode; and
(b) concurrently, flushing the measuring electrode with an electrolytic cleaning solution to remove metal residue from such measuring electrode.

Preferably, the electrolytic cleaning solution comprises diluted sulfuric acid at a concentration of from about 0.01M to about 0.5M, and more preferably from about 0.05M to about 0.15M.

Other aspects, features and embodiments of the present invention will be more fully apparent from the ensuing disclosure and appended claims.

### BRIEF DESCRIPTION OF THE DRAWINGS

FIG. 1 shows three current response curves obtained under cyclic electric potentials for three electrolytic solutions, which contain copper ions at three different concentrations.

FIG. 2 shows seven current response curves obtained under cyclic electric potentials for seven electrolytic solutions, which contain copper ions at seven different concentrations.

FIG. 3 shows a calibration curve that correlates copper concentrations with the integrated areas of selected current peaks in the current response curves of FIG. 2.

FIG. 4 shows nine current response curves obtained under cyclic electric potentials for nine electrolytic solutions, which contain sulfuric acid at nine different concentrations.

FIG. 5 shows a calibration curve that correlates sulfuric acid concentrations with the integrated areas of selected current peaks in the current response curves of FIG. 4.

FIG. 6 shows five current response curves obtained under cyclic electric potentials for five electrolytic solutions, which contain copper ions at the same concentration and sulfuric acid at five different concentrations.

FIG. 7 shows a calibration curve that correlates sulfuric acid concentrations with the integrated areas of selected current peaks in the current response curves of FIG. 6.

FIG. 8 shows three current response curves respectively obtained under cyclic electric potential for (1) a copper-free electrolytic solution, (2) an electrolytic solution as contained in a flow-stripped analytical cell, and (3) an electrolytic solution as contained in a analytical cell cleaned by sequential flushing and stripping steps.

### DETAILED DESCRIPTION OF THE INVENTION, AND PREFERRED EMBODIMENTS THEREOF

In an electrochemical analytical cell used for analyzing sample copper ECD solutions, a thin layer of copper is formed on the measuring electrode of such analytical cell after each analysis cycle. To prepare the cell for next sample analysis, the electrochemical analytical cell has to be flushed with diluted sulfuric acid solution to remove any residue chemicals, and the copper layer has to be removed by electrochemically stripping.

However, trace amount of copper residue may still present in the analytical cell, even after the flushing and stripping. To prevent copper residue from contaminating the analytical cell and causing measurement errors in the next sample analysis, the present invention provides a method for determining the presence and concentration of copper residue in the analytical cell after the flushing/cleaning cycle, and to take necessary actions (i.e., further flushing and/or stripping) if the copper concentration therein is still above a predetermined threshold level.

Specifically, such electrochemical analytical cell is first filled with a copper-free electrolytic solution (for example, a diluted H₂SO₄ solution). If such electrochemical analytical cell does not contain copper residue, the electrolytic solution filled thereinto will remain copper-free; otherwise the electrolytic solution will contain copper residue, which can be readily detected by the ensuring electrochemical process.

A cyclic electrical potential is applied between a first and a second electrode, both of which are immersed in the electrolytic solution, for cyclic voltammetry (CV) scan of such electrolytic solution. During the CV scan, the copper residue contained in the electrolytic solution undergoes reduction and oxidation in a cyclic manner, resulting in reduction and oxidation current peaks that are correlative to the copper concentration in such electrolytic solution.

Concentration of copper residue in such electrolytic solution can be determined by analyzing the characteristic current response of the electrolytic solution under the cyclic electric potential, and specifically by analyzing the copper reduction and/or oxidation peaks. Presence and concentration of copper residue in the electrochemical analytical cell can then be inferred based on copper concentration in the electrolytic solution.

The present invention therefore in one aspect relates to a method for cleaning an electrolytic analytical cell used for analyzing copper electroplating solutions. Such method comprises the steps of:
(a) flushing such electrolytic analytical cell with an electrolytic cleaning solution;
(b) electrically stripping a measuring electrode of such analytical cell to remove a copper layer from such measuring electrode, wherein such copper layer is formed on the measuring electrode during a previous analysis cycle;
(c) subsequently, filling the electrolytic analytical cell with a copper-free electrolytic solution, wherein the measuring electrode and an auxiliary electrode are immersed in such electrolytic solution;
(d) applying a cyclic electric potential between the measuring and auxiliary electrodes and monitoring current response of such electrolytic solution;
(e) determining presence and/or concentration of copper residue in such electrolytic solution, based on characteristic current response of the electrolytic solution under the cyclic electric potential; and
(f) optionally, repeat steps (a)-(e).

In a preferred embodiment of the present invention, the characteristic current response of the electrolytic solution in the electrochemical analytical cell is compared with the current response of a known copper-free electrolytic solution, for better identification of any copper reduction and/or oxidation current peaks. In a further preferred embodiment of the present invention, the characteristic current response of the sample electrolytic solution in the electrochemical analytical cell is further compared with the current responses of one or more calibration solutions that contain copper at known concentrations, for estimation of copper concentration in such sample solution.

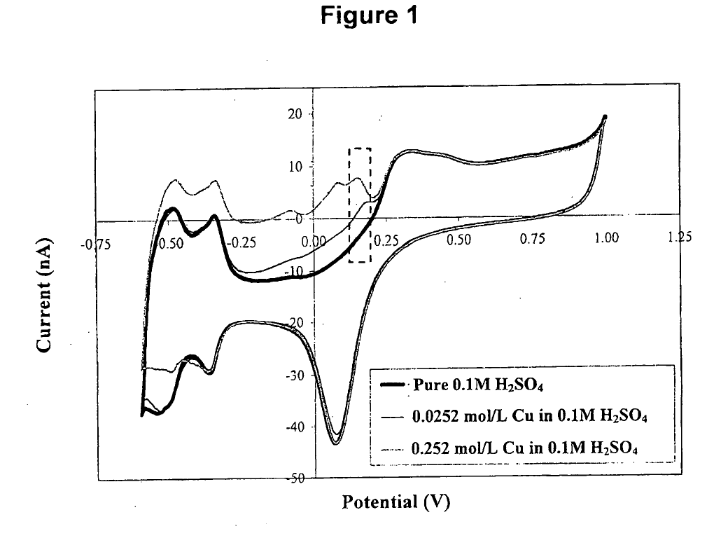

FIG. 1 shows the current response curves of three electrolytic solutions obtained under a cyclic electropotential that oscillates between −0.6 volt and +1.0 volt with a scan rate of about 300 mV/second. The first electrolytic solution is a diluted copper-free sulfuric acid solution (0.1M); the second electrolytic solution is a diluted sulfuric acid solution (0.1M) containing copper at a concentration of about 0.0252 mol/L; the third electrolytic solution is a diluted sulfuric acid solution (0.1M) containing 0.252 mol/L copper therein.

As shown in FIG. 1, the current response curve of the copper-free sulfuric acid solution contains no current peak within the electrical potential range marked by the dotted rectangular box (approximately the copper oxidation potential range for Cu⁺ to become Cu²⁺). In contrast, the response curve of the sulfuric acid solution with 0.0252 mol/L copper therein shows a small current peak within such potential range, and the response curve of the sulfuric acid solution with 0.252 mol/L copper therein shows a very significant current peak.

Therefore, the current response curve of a sample electrolytic solution of unknown copper content can be compared with the current response curve of a copper-free electrolytic solution, to determine the presence of copper in such sample solution.

Further, since the copper oxidation peak measured for an electrolytic solution quantitatively correlates with the respective copper concentration in such solution, the current response curves of multiple calibration solutions, which contain copper at unique, known concentrations, can be used to map copper concentration of an unknown sample solution.

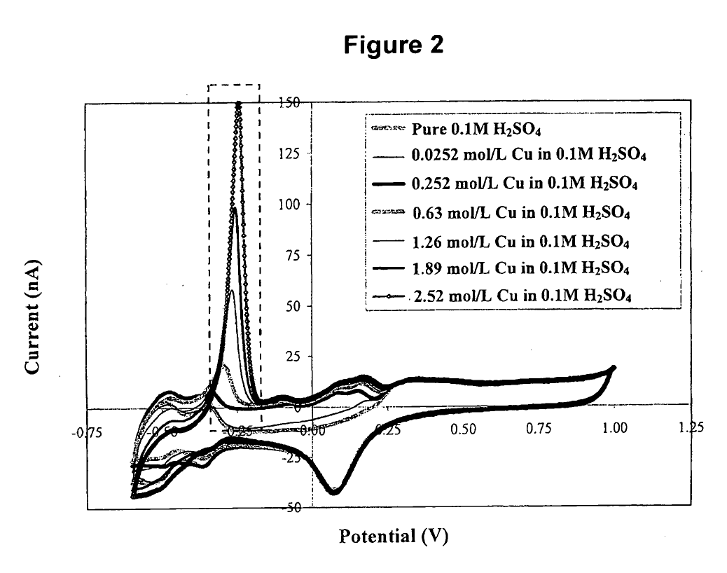

FIG. 2 shows the current response curves of seven electrolytic calibration solutions obtained under a cyclic electropotential that oscillates between −0.6 volt and +1.0 volt with a scan rate of about 300 mV/second. The first calibration solution is a diluted copper-free sulfuric acid solution (0.1M); the second calibration solution is a diluted sulfuric acid solution (0.1M) containing copper at a concentration of about 0.0252 mol/L; the third calibration solution is a diluted sulfuric acid solution (0.1M) containing about 0.252 mol/L copper; the fourth calibration solution is a diluted sulfuric acid solution (0.1M) containing about 0.63 mol/L copper; the fifth calibration solution is a diluted sulfuric acid solution (0.1M) containing about 1.26 mol/L copper; the sixth calibration solution is a diluted sulfuric acid solution (0.1M) containing about 1.89 mol/L copper; finally, the seventh calibration solution is a diluted sulfuric acid solution (0.1M) containing about 2.52 mol/L copper.

As shown in FIG. 2, current response curves of the above-listed calibration solutions contain sharply distinguishable current peaks within the electrical potential range marked by the dotted rectangular box (approximately the copper oxidation potential range for Cu to become Cu⁺). Although such current response curves also contain distinguishable current peaks within the copper oxidation range for Cu⁺ to Cu²⁺ conversion, peaks within the copper oxidation range for Cu to Cu⁺ conversion are preferably selected for copper concentration mapping, due to the higher signal strength demonstrated by such selected current peaks.

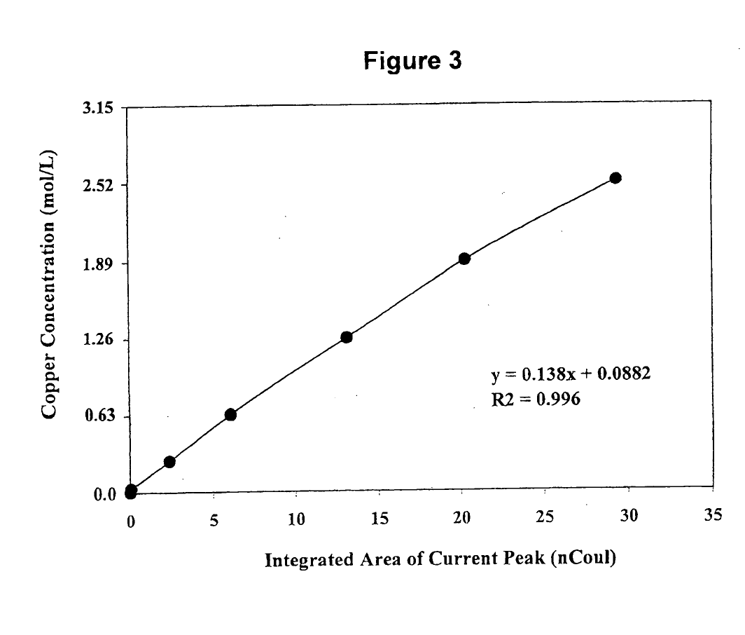

In subsequent copper concentration mapping, the integrated areas of the selected copper oxidation current peaks in the current response curves of FIG. 2 are calculated. The known copper concentrations of the calibration solutions are then plotted as a function of such integrated peak areas, to form a calibration curve that quantitatively correlates integrated current peak areas with copper concentrations, as shown in FIG. 3. The copper concentration in an unknown sample solution can be directly mapped out on such calibration curve after obtaining a current response curve for such sample solution under the cyclic electropotential and calculating the integrated areas of the corresponding copper oxidation peak in the sample current response curve.

The above-described copper concentration mapping technique is particularly useful for ECD bath analysis. It is quicker, simpler, and requires much less sample solution, in comparison with the conventional titration methods commonly used for analyzing copper concentration in an ECD bath.

Therefore, the present invention in another aspect relates to a method for determining concentration of copper in an electrochemical copper plating solution, comprising the steps of:
(a) immersing in such electrochemical copper plating solution a first electrode and a second electrode;
(b) applying a cyclic electric potential between the first and second electrodes;
(c) concurrently, monitoring current response of such electrochemical copper plating solution under the cyclic electric potential; and
(d) determining the concentration of copper in such electrochemical copper plating solution, based on characteristic current response thereof under the cyclic electric potential.

Preferably, copper concentration in the electrochemical copper plating solution is determined by calculating the integrated area of a selected current peak in the current response curve obtained for such electrochemical copper plating solution and identifying copper concentration correlating to such integrate area on a calibration curve or other type of correlative data set that correlates copper concentrations with integrated areas of selected current peaks in current response curves.

The copper concentration mapping technique described hereinabove is also useful for determining copper concentration in any other type of electrolytic solutions that contain copper or are susceptible to the presence of copper.

Further, the current response curves can be used for determining concentration of other inorganic components besides copper, which include but are not limited to, other metal ions, acids, and/or bases.

In a preferred embodiment of the present invention, the current response curves are used for determining sulfuric acid concentrations in sulfuric acid solutions.

Specifically, sulfuric acid undergoes reversible ionization in the electrolytic solution under the influence of the cyclic electropotential, forming hydrogen ions and sulfate ions, as follows:
H₂SO₄⇄H⁺+HSO₄⁻⇄2H⁺+SO₄²⁻

The ionization and absorption of hydrogen in the electrolytic solution causes corresponding current fluctuations, which results in hydrogen ionization or absorption current peaks in the current response curve of such electrolytic solution.

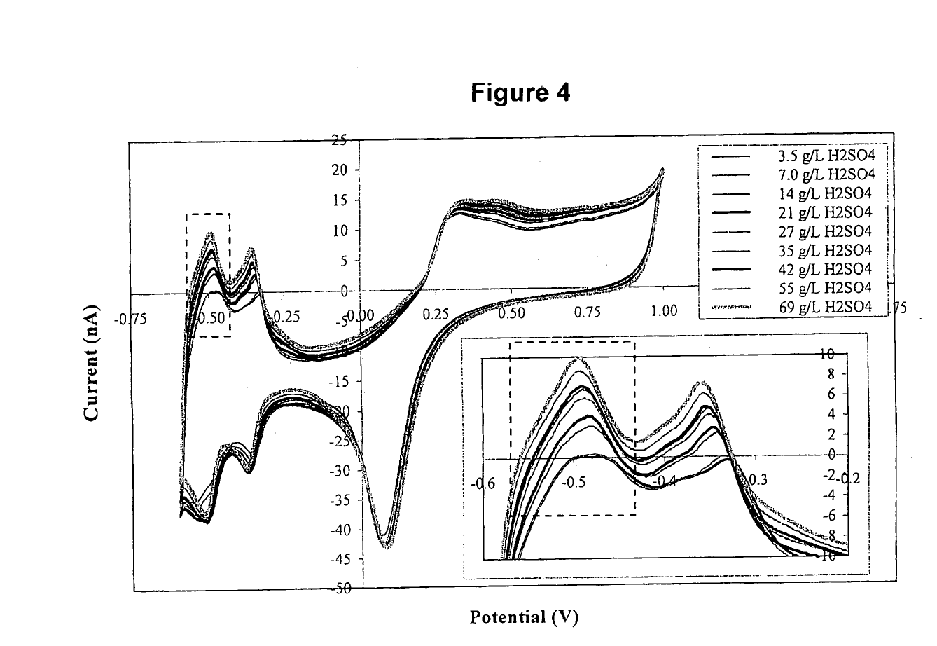

FIG. 4 shows the current response curves of nine sulfuric acid calibration solutions, as obtained under a cyclic electropotential that oscillates between −0.6 volt and +1.0 volt with a scan rate of about 300 mV/second. The first calibration solution contains sulfuric acid at a concentration of about 3.5 g/L; the second calibration solution contains sulfuric acid at a concentration of about 7.0 g/L; the third calibration solution contains sulfuric acid at a concentration of about 14 g/L; the fourth calibration solution contains sulfuric acid at a concentration of about 21 g/L; the fifth calibration solution contains sulfuric acid at a concentration of about 27 g/L; the sixth calibration solution contains sulfuric acid at a concentration of about 35 g/L; the seventh calibration solution contains sulfuric acid at a concentration of about 42 g/L; the eight calibration solution contains sulfuric acid at a concentration of about 55 g/L; and finally, the ninth calibration solution contains sulfuric acid at a concentration of about 69 g/L.

As shown in FIG. 2, each current response curve contains several distinguishable current peaks. The two lower peaks at electropotential of about −0.30 volt and −0.53 volt are hydrogen absorption peaks, while the two upper peaks at electropotential of about −0.35 volt and −0.49 volt are hydrogen ionization peaks. The upper peak at electropotential of about −0.49 volt (as marked by the dotted rectangular box) is characterized by the strongest signal strength and therefore is selected for sulfuric acid concentration mapping.

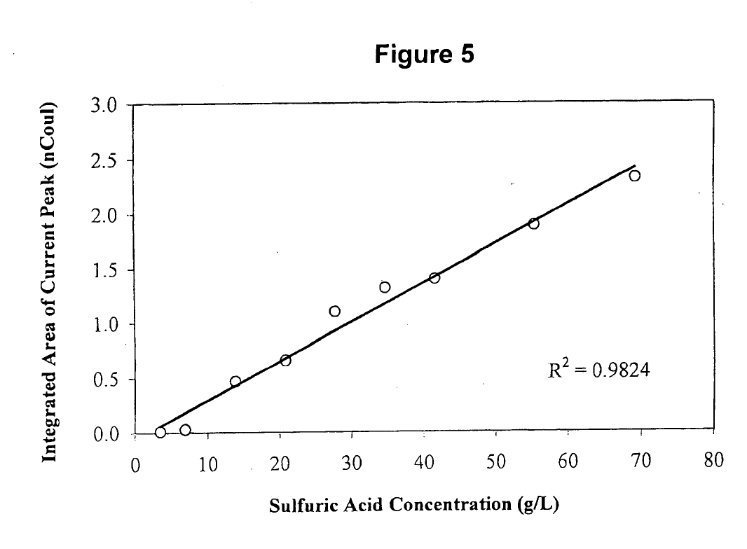

Subsequently, the integrated areas of the selected hydrogen ionization current peaks in the current response curves of FIG. 4 are calculated. The known sulfuric acid concentrations of the calibration solutions are then plotted as a function of such integrated peak areas, to form a calibration curve that quantitatively correlates integrated current peak areas with sulfuric acid concentrations, as shown in FIG. 5. The sulfuric acid concentration in an unknown sample solution can be directly mapped out on such calibration curve after obtaining the current response curve of such sample solution under the cyclic electropotential and calculating the integrated areas of the corresponding hydrogen ionization peak in the sample current response curve.

Therefore, the present invention in yet another aspect relates to a method for determining concentration of sulfuric acid in an electrolytic solution, comprising the steps of:
(a) immersing in such electrolytic solution a first electrode and a second electrode;
(b) applying a cyclic electric potential between the first and second electrodes;
(c) concurrently, monitoring current response of such electrolytic solution under the cyclic electric potential; and
(d) determining the concentration of sulfuric acid in such electrolytic solution, based on characteristic current response thereof under the cyclic electric potential.

Methods of the present invention can also be used for determining the concentration of an inorganic compound of interest in an electrolytic solution that contains two or more inorganic components.

Further, the current peaks selected for concentration mapping are not necessarily current peaks formed by reactions of the inorganic compound of interest. Instead, the current peaks selected for concentration mapping of a first compound can in fact be formed by reactions of the second compound, as far as the reactions of the second compound is impacted by the concentration of the first compound in the solution.

For example, in an electrolytic solution that comprises both copper and sulfuric acid, the copper oxidation and reduction reactions in such electrolytic solution are related to the sulfuric acid concentration therein. Therefore, for a fixed copper concentration, the copper oxidation or reduction current peaks are correlative to the sulfuric acid concentration in the solution, and therefore can be used for mapping sulfuric acid concentration.

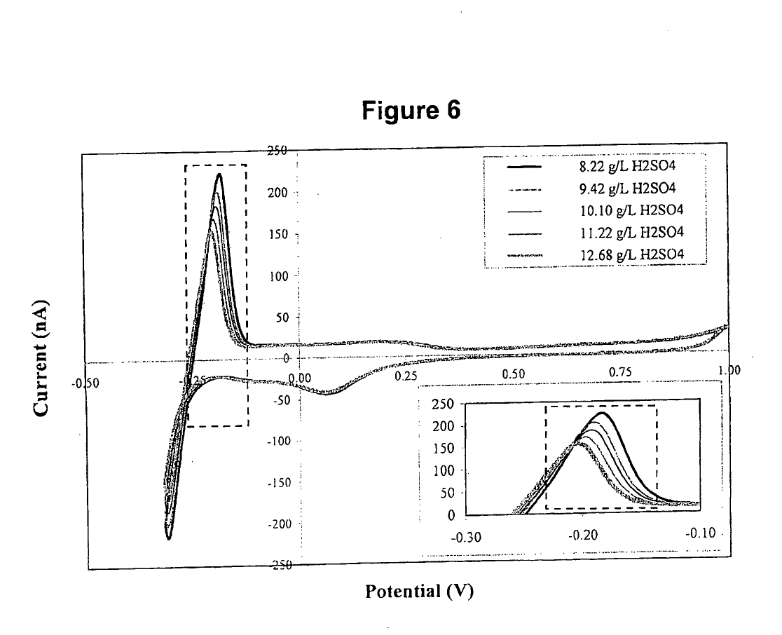

FIG. 6 shows the current response curves of five calibration solutions, as obtained under a cyclic electropotential that oscillates between −0.32 volt and +1.0 volt with a scan rate of about 300 mV/second. All the calibration solutions contain copper at the same concentration and sulfuric acid at different concentrations. Specifically, the first calibration solution contains sulfuric acid at a concentration of about 8.22 g/L; the second calibration solution contains sulfuric acid at a concentration of about 9.42 g/L; the third calibration solution contains sulfuric acid at a concentration of about 10.10 g/L; the fourth calibration solution contains sulfuric acid at a concentration of about 11.22 g/L; the fifth calibration solution contains sulfuric acid at a concentration of about 12.68 g/L.

As shown in FIG. 6, the current response curves contain sharply distinguishable current peaks within the electrical potential range marked by the dotted rectangular box (approximately the copper oxidation potential range for Cu to become Cu⁺), which can be selected for sulfuric acid concentration mapping.

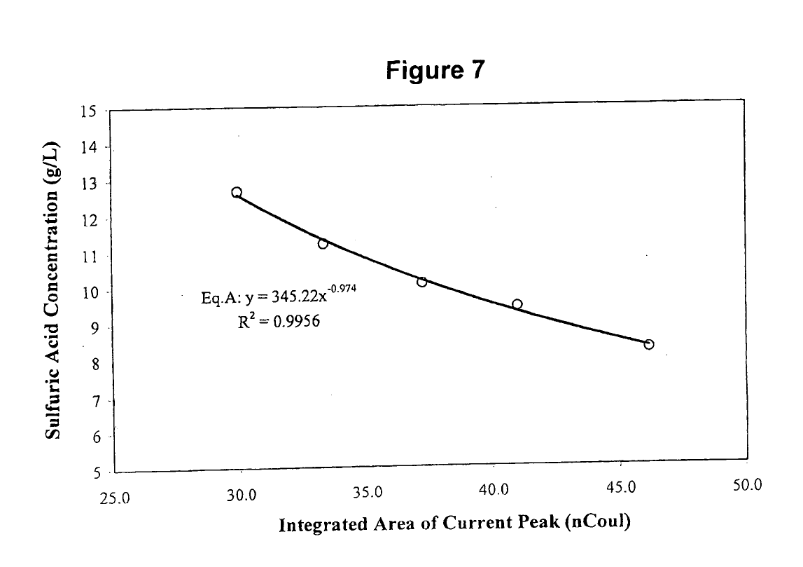

Subsequently, the integrated areas of the selected copper oxidation peaks in the current response curves of FIG. 6 are calculated. The known sulfuric acid concentrations of the calibration solutions are then plotted as a function of such integrated peak areas, to form a calibration curve that quantitatively correlates integrated current peak areas with sulfuric acid concentrations, as shown in FIG. 7. The sulfuric acid concentration in an unknown sample solution can be directly mapped out on such calibration curve after obtaining the current response curve of such sample solution under the cyclic electropotential and calculating the integrated areas of the corresponding copper oxidation peak in the sample current response curve.

Therefore, the present invention in yet another aspect relates to a method for determining concentration of a first inorganic compound in an electrolytic solution that comprises said first inorganic compound and at least a second inorganic compound, comprising the steps of:
(a) immersing in such electrolytic solution a first electrode and a second electrode;
(b) applying a cyclic electric potential between the first and second electrodes;
(c) concurrently, monitoring current response of such electrolytic solution under the cyclic electric potential;
(d) determining the concentration of the first inorganic compound in the electrolytic solution, based on current peaks generated by reactions of the second inorganic compound in such electrolytic solution under the cyclic electric potential.

A further aspect of the present invention relates to use of cyclic electropotential for cleaning a measuring electrode of an electrochemical analytical cell.

The presence of surface-active materials in sample ECD solution leads to formation of a surface residual layer on the measuring electrode after multiple analysis cycles, resulting in electrode passivation or a change in the electrode surface state, and causing significant measurement errors over time. Maintenance of a clean, reproducible electrode surface therefore is of critical importance in making meaningful electroanalytical measurements.

The present invention therefore employs cyclic electropotential for in situ cleaning of the measuring electrode. The cyclic electropotential-based cleaning method of the present invention does not require removal of such measuring electrode from the analytical cell, thereby significantly reducing the system down time required for electrode cleaning and simplifying the cleaning process. Additionally, cyclic electropotential-based cleaning of the present invention reduces physical damage to the electrode surface and the measurement errors associated therewith.

The cyclic electropotential-based cleaning can be carried out immediately after an analysis cycle, while the sample electrolytic solution previously analyzed is used for the cleaning purposes.

Alternatively, the analytical cell is first emptied and then filled with an electrolytic cleaning solution. Cleaning solutions comprising sulfuric acid and/or potassium sulfate are particularly efficient in removing surface contamination from the measuring electrode during a cyclic voltammetry-based cleaning process. More preferably, electrolytic cleaning solutions comprising sulfuric acid of about 0.1M to about 0.3M and optionally potassium sulfate of about 0.2M to about 0.6M are employed for practice of the present invention, and most preferably, an electrolytic cleaning solution comprising sulfuric acid of about 0.2M and potassium sulfate of about 0.4M is used.

The measuring electrode to be cleaned is immersed in the sample electrolytic solution or the electrolytic cleaning solution, together with an auxiliary electrode, which can be either an Hg/HgSO₄ reference electrode or other types of electrodes. A cyclic electric potential is applied between such measuring electrode and auxiliary electrode for a sufficient number of cycles, to oxidize and reduce surface species adsorbed on the electrode surface. Further, such cyclic electric potential results in formation of hydrogen and oxygen micro-bubbles on the electrode surface, while such micro-bubbles continuously shed off and removes surface deposit from the electrode surface.

Preferably, the cyclic electric potential oscillates between about −2 volts and about +4 volts, more preferably between about −1 volts and about +2 volts, and most preferably between about −0.8 volts and about +1.3 volts, for effective in situ cleaning of the measuring electrode. The scan rate of such cyclic electric potential is preferably within a range of from about 50 mV/second to about 3,000 mV/second, and more preferably from about 100 mV/second to about 2,330 mV/second.

Such cyclic electric potential is preferably applied upon the measuring and auxiliary electrodes for at least 5 cycles, and more preferably at least 10 cycles, and most preferably at least 25 cycles.

The cyclic electropotential-based cleaning method of the present invention is particularly effective in removing copper, copper oxide, and organic species from the electrode surface.

A still further aspect of the present invention relates to a flow-stripping method for cleaning an electrochemical analytical cell that is used for analyzing copper electro-plating solutions.

During a conventional cleaning cycle, the electrochemical analytical cell is first flushed with a diluted sulfuric acid solution to remove any residue chemicals from the cell. The copper layer formed on the measuring electrode during a previous analysis is then removed by electrochemically stripping.

However, during the stripping process, the copper stripped off the electrode surface enters the electrolytic solution as copper ions, which may deposit on other parts of the analytical cell or again form copper film on the measuring electrode. The copper film or copper deposit, once formed, is difficult to remove by subsequent flushing.

The present invention solves such problem by providing a flow-stripping method, in which the electrochemical stripping is carried out in a flowing electrolytic cleaning solution. In other words, the analytical cell is concurrently flushed during the electrochemical stripping process, to remove the copper residue that has been stripped off the measuring electrode out of the analytical cell before it deposits on any part of the cell.

For example, a measuring electrode comprising a platinum tip is electrochemically stripped at about 0.7V for about 40 seconds, during which a cleaning solution comprising 0.1M sulfuric acid is used to concurrently flush the analytical cell.

Copper contamination in such analytical cell after flow-stripping is then analyzed, by filling such analytical cell with a fresh electrolytic cleaning solution that is copper-free, applying a cyclic electropotential between the measuring electrode and an auxiliary electrode, and monitoring the current response generated by such electrolytic cleaning solution under the cyclic electropotential.

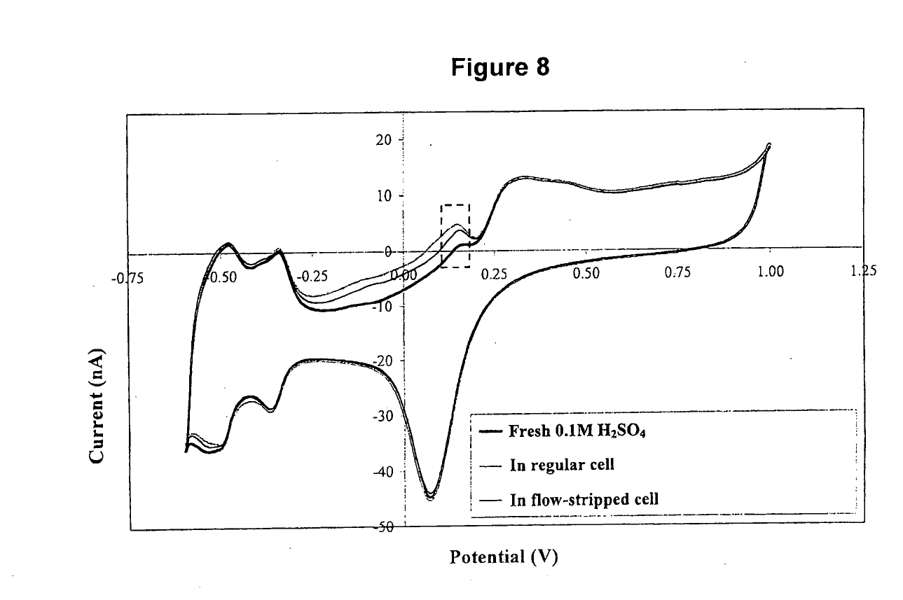

The current response curve of the electrolytic cleaning solution is obtained and then compared to those obtained for a copper-free electrolytic solution and an electrolytic solution in an analytical cell cleaned by the conventional method (i.e., flushing followed by stripping), as in FIG. 8.

The copper oxidation current peaks indicated by the dotted rectangle correlate with the copper concentrations in the flow-stripped analytical cell, the analytical cell cleaned by the conventional method, and the fresh copper-free electrolytic cleaning solution comprising 0.1M H₂SO₄. The copper concentration in the flow-stripped analytical cell is about 40% less than that in the analytical cell cleaned by the conventional method.

Therefore, it is desirable to employ the flow-stripping method of the present invention to reduce copper contamination in an electrochemical analytical cell.

Such flow-stripping method is generally applicable for cleaning of any electrochemical analytical cell susceptible to metal contamination.

While the ensuing description is directed to an electrochemical deposition (ECD) system involving application of a constant plating current in a copper sulfate/sulfuric acid/chloride solution and measurement of the resulting potential to provide a signal transient as a unique signature indicative of the composition of the solution in the ECD bath, it will be recognized that the methodology and apparatus of the invention are not thus limited, but rather generally extend to and encompass the determination of analytes in fluid media. For example, although the present description is directed primarily to copper deposition, the invention is readily applicable to other ECD process applications, including deposition of silver, gold, iridium, palladium, tantalum, titanium, chromium, cobalt, tungsten, etc., as well as deposition of alloys and deposition of amalgams such as solder.

Examples of additional applications of the invention other than ECD plating of semiconductor device structures include analysis of reagents in reaction media for production of therapeutic agents such as pharmaceutical products, and biotechnology applications involving the concentrations of specific analytes in human blood or plasma. It will therefore be appreciated that the invention is of broad application, and that the ECD system and method described hereafter is but one of a myriad of potential uses for which the invention may be employed.

While the invention has been described herein with reference to specific aspects, features and embodiments, it will be recognized that the invention is not thus limited, but rather extends to and encompasses other variations, modifications and alternative embodiments. Accordingly, the invention is intended to be broadly interpreted and construed to encompass all such other variations, modifications, and alternative embodiments, as being within the scope and spirit of the invention as hereinafter claimed.

1. A method for cleaning an electrolytic analytical cell, comprising the steps of:
(a) flushing said electrolytic analytical cell with an electrolytic cleaning solution;
(b) electrically stripping a measuring electrode of such analytical cell for removal of a metal layer from the measuring electrode, wherein said metal layer is formed on the measuring electrode during a previous analysis;
(c) subsequently, filling the electrolytic analytical cell with a metal-free electrolytic solution, wherein the measuring electrode and an auxiliary electrode are immersed in said electrolytic solution;
(d) applying a cyclic electric potential between the measuring and auxiliary electrodes and monitoring current response of said electrolytic solution;
(e) determining presence and/or concentration of metal residue in said electrolytic solution, based on characteristic current response of the electrolytic solution under the cyclic electric potential; and
(f) optionally, repeating steps (a)-(e).

2. The method of claim 1, wherein the metal layer comprises copper or copper alloy.

3. The method of claim 1, wherein the metal-free electrolytic solution comprises sulfuric acid.

4. The method of claim 1, wherein the cyclic electric potential cycles between about −2.0 V and about +4 V.

5. The method of claim 1, wherein the cyclic electric potential cycles between about −1 V and about +2 V.

6. The method of claim 1, wherein the cyclic electric potential cycles between about −0.6 V and about +1 V.

7. The method of claim 1, wherein the current response of the electrolytic solution is compared with current responses of one or more calibration solutions under the cyclic electric potential, wherein the calibration solutions contain said metal residue at known concentrations.

8. A method for determining presence and/or concentration of an inorganic component in an electrolytic solution, comprising the steps of:
(a) immersing in said electrolytic solution a first electrode and a second electrode;
(b) applying a cyclic electric potential between said first and said second electrodes;
(c) concurrently, monitoring the electrical current that flows through the electrolytic solution between the first and second electrodes; and
(d) determining the presence and/or concentration of the inorganic component in said electrolytic solution, based on characteristic current response of the electrolytic solution under the cyclic electric potential.

9. A method for determining presence and/or concentration of copper in an electrolytic solution that contains copper or is susceptible to presence of copper, said method comprising the steps of:
(a) immersing in said electrolytic solution a first electrode and a second electrode;
(b) applying a cyclic electric potential between said first and said second electrodes;
(c) concurrently, monitoring the electrical current that flows through the electrolytic solution between the first and second electrodes; and
(d) determining the presence and/or concentration of copper in said electrolytic solution, based on characteristic current response of the electrolytic solution under the cyclic electric potential.

10. The method of claim 9, wherein the cyclic electric potential cycles between about −2.0 V and about +4 V.

11. The method of claim 9, wherein the cyclic electric potential cycles between about −1 V and about +2 V.

12. The method of claim 9, wherein the cyclic electric potential cycles between about −0.6 V and about +1 V.

13. The method of claim 9, wherein the current response of the electrolytic solution is compared with current responses of one or more calibration solutions under the cyclic electric potential, wherein the calibration solutions contain copper at known concentrations.

14. A method for determining sulfuric acid concentration in an electrolytic solution containing the same, said method comprising the steps of:
(a) immersing in said electrolytic solution a first electrode and a second electrode;
(b) applying a cyclic electric potential between said first and said second electrodes;
(c) concurrently, monitoring the electrical current that flows through the electrolytic solution between the first and second electrodes; and
(d) determining the presence and/or concentration of sulfuric acid in said electrolytic solution, based on characteristic current response of the electrolytic solution under the cyclic electric potential.

15. The method of claim 14, wherein the cyclic electric potential cycles between about −2.0 V and about +4 V.

16. The method of claim 14, wherein the cyclic electric potential cycles between about −1 V and about +2 V.

17. The method of claim 14, wherein the cyclic electric potential cycles between about −0.6 V and about +1 V.

18. The method of claim 14, wherein the current response of the electrolytic solution is compared with current responses of one or more calibration solutions under the cyclic electric potential, wherein the calibration solutions contain sulfuric acid at known concentrations.

19. A method for determining concentration of a first inorganic compound in an electrolytic solution that comprises said first inorganic component and at least a second inorganic component, said method comprising the steps of:
(a) immersing in said electrolytic solution a first electrode and a second electrode;
(b) applying a cyclic electric potential between the first and second electrodes;
(c) concurrently, monitoring current response of said electrolytic solution under the cyclic electric potential;
(d) determining the concentration of the first inorganic component in the electrolytic solution, based on current peaks generated by reactions of the second inorganic component in said electrolytic solution under the cyclic electric potential.

20. The method of claim 19, wherein said first inorganic component comprises sulfuric acid, and wherein said second inorganic component comprises copper and/or copper ions.

21. The method of claim 20, wherein the cyclic electric potential cycles between about −2 V and about +4 V.

22. The method of claim 20, wherein the cyclic electric potential cycles between about −1 V and about +2 V.

23. The method of claim 20, wherein the cyclic electric potential cycles between about −0.32 V and about +1 V.

24. The method of claim 19, wherein the current peaks generated by reactions of the second inorganic component in said electrolytic solution is compared with current peaks generated by reactions of the second inorganic component in one or more calibration solutions under the cyclic electric potential, wherein the calibration solutions contain the first inorganic component at unique, known at known concentrations and the second inorganic component at the same concentration as that of the electrolytic solution.

25. A method for cleaning a measuring electrode, comprising the steps of:
(a) immersing said measuring electrode and an auxiliary electrode in a sample electrolytic solution or an electrolytic cleaning solution; and
(b) applying a cyclic electric potential between said measuring electrode and the auxiliary electrode for in situ cleaning and depassivating said measuring electrode.

26. The method of claim 25, wherein an electrolytic cleaning solution is employed.

27. The method of claim 26, wherein said electrolytic cleaning solution comprises sulfuric acid.

28. The method of claim 27, wherein said electrolytic cleaning solution comprises sulfuric acid at a concentration of from about 0.1M to about 0.3M.

29. The method of claim 27, wherein said electrolytic cleaning solution further comprises potassium sulfate.

30. The method of claim 29, wherein said electrolytic cleaning solution comprises potassium sulfate at a concentration of from about 0.2M to about 0.6M.

31. The method of claim 25, wherein the cyclic electric potential cycles between about −2 V and about +4 V.

32. The method of claim 25, wherein the cyclic electric potential cycles between about −1 V and about +2 V.

33. The method of claim 25, wherein the cyclic electric potential cycles between about −0.8 V and about +1.3 V.

34. The method of claim 25, wherein the cyclic electric potential is applied for at least 5 cycles.

35. The method of claim 25, wherein the cyclic electric potential is applied for at least 10 cycles.

36. A method for cleaning a measuring electrode with a thin metal layer coated thereon, comprising the steps of:
(a) electrochemically stripping said thin metal layer off the measuring electrode; and
(b) concurrently, flushing said measuring electrode with an electrolytic cleaning solution to remove metal residue from said measuring electrode.

37. The method of claim 36, wherein said thin metal layer comprises copper or copper alloy.

38. The method of claim 37, wherein the electrolytic cleaning solution comprises a diluted sulfuric acid solution.
